(19) United States
(12) Patent Application Publication
(10) Pub. No.: US 2004/0215696 A1
(43) Pub. Date: Oct. 28, 2004

(54) Method and apparatus for generating a message with embedded content

(76) Inventors: Clay Fisher, Belmont, CA (US); Hawley Rising III, San Jose, CA (US); Ali Tabatabai, Cupertino, CA (US); Eric Edwards, San Jose, CA (US)

Correspondence Address: Valley Oak Law, #106, 5655 Silver Creek Valley Road, San Jose, CA, 95138, US

(21) Appl. No.: 10/403,536

(22) Filed: Mar. 31, 2003

(51) Int. Cl. G06F 15/16

(52) U.S. Cl. 709/201

(57) ABSTRACT

The invention illustrates a system and method of embedding a link within an electronic message. In one embodiment, the system and method comprises: initiating an electronic mail message; selecting a content for attachment to the electronic mail message; automatically creating a URL corresponding to the content; and automatically embedding the URL within the electronic mail message. Other aspects and advantages of the invention will become apparent from the following detailed description, taken in conjunction with the accompanying drawings, illustrated by way of example of the principles of the invention.

### FIELD OF THE INVENTION

The present invention relates generally to transmitting a message and, more particularly, to transmitting a message with embedded content.

### BACKGROUND OF THE INVENTION

There has been an increased use of computers both for personal use and business use. With the prices of computers decreasing, more people have access to computers. With the increased use of computers, access to the Internet has also proliferated.

Even with the increased use of computers and the Internet, many people are still not familiar with the use of applications on a computer and applications accessible through the Internet. For example, many users are able to operate basic functions such as sending electronic mail messages to recipients. However, many users do not have the skills to send an attachment file with their electronic mail messages.

Further, many electronic mail messenging services do not support the transmission of files above a predetermined file size. Some electronic mail messenging services limit the file size of attachments, because they lack the internal resources to process attachments above the predetermined file size. Further, with the more senders taking advantage of free or low cost electronic mail accounts, more users may become affected by the limit in file size attachments.

### SUMMARY OF THE INVENTION

The invention illustrates a system and method of embedding a link within an electronic message. In one embodiment, the system and method comprises: initiating an electronic mail message; selecting a content for attachment to the electronic mail message; automatically creating a URL corresponding to the content; and automatically embedding the URL within the electronic mail message.

Other aspects and advantages of the invention will become apparent from the following detailed description, taken in conjunction with the accompanying drawings, illustrated by way of example of the principles of the invention.

### BRIEF DESCRIPTION OF THE DRAWINGS

The accompanying drawings, which are incorporated in and constitute a part of this specification, illustrate one embodiment of the invention and, together with the description, explain one embodiment of the invention. In the drawings,

FIG. 1 is a diagram illustrating an environment within which the invention may be implemented.

FIG. 2 is a simplified block diagram illustrating one embodiment in which the invention may be implemented.

FIG. 3 is a simplified block diagram illustrating a system, consistent with one embodiment of the invention.

FIG. 4 is a flow diagram consistent with one embodiment of the invention.

FIG. 5 is a flow diagram consistent with one embodiment of the invention.

FIG. 6 is a flow diagram consistent with one embodiment of the invention.

### DETAILED DESCRIPTION

The following detailed description of the invention refers to the accompanying drawings. The detailed description does not limit the invention. Instead, the scope of the invention is defined by the appended claims and equivalents.

The invention includes methods and apparatus for embedding content within an electronic mail message. The invention also includes methods and apparatus for creating a link associated with the content stored on a remote device. The invention also includes methods and apparatus for automatically attaching the link associated with the content onto the electronic mail message.

In one embodiment, the content may include a variety of items such as an image, a document, a music selection, and the like. For simplicity and clarity, the various embodiments of the invention are shown using an image and/or corresponding image data to represent the content. The invention is not intended to be limited to be utilized with any particular type of content.

Those skilled in the art will recognize that many other implementations are possible, consistent with the present invention.

A. Environment and Architecture

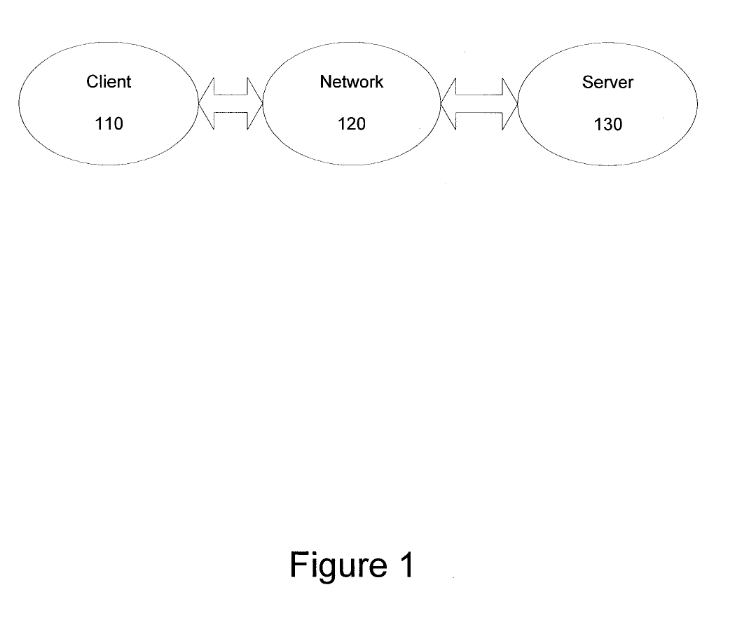

FIG. 1 is a diagram illustrating an environment within which the invention may be implemented. The environment includes a client 110, a network 120, and a server 130.

The client 110 may be a consumer electronics device. The consumer electronics device may include a computer, a digital camera, a telephone, a pager, and the like. The client 110 may be configured to be utilized by a sender.

The network 120 interfaces with the client 110, and the server 130. In one embodiment, the network 120 is the Internet. In another embodiment, the network 120 may be any transmission medium between the client 110 and the server 130.

The sever 130 is a device configured to interface with the client 110 through the network 120.

The client 110 and/or the server 130 may include a combination of software, hardware, and/or firmware to provide functionality for the invention.

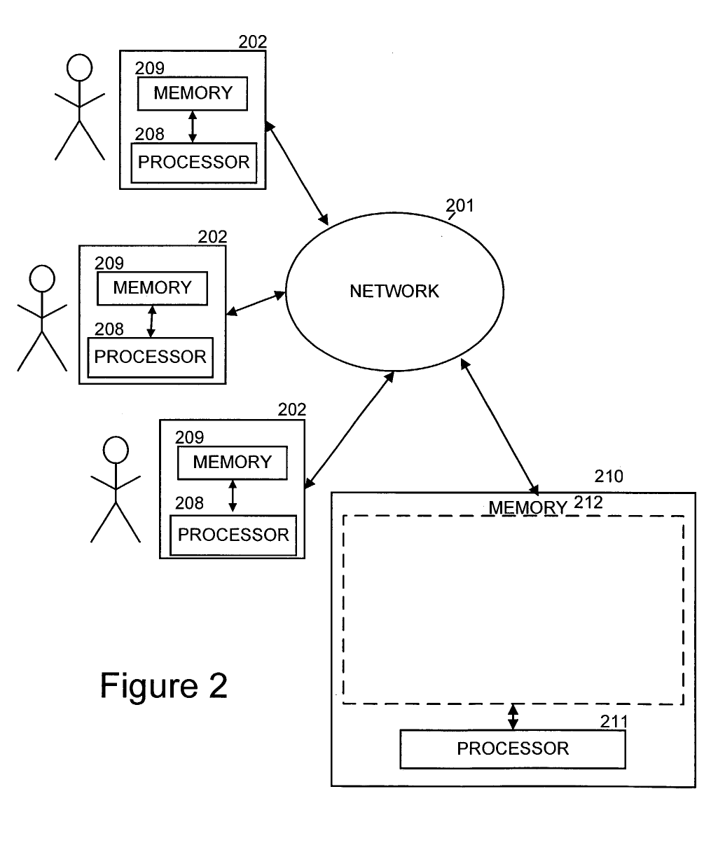

FIG. 2 is a simplified diagram illustrating an exemplary architecture in which the present invention may be implemented. The exemplary architecture includes a plurality of client devices 202, a server device 210, and a network 201. In one embodiment, the network 201 may be the Internet.

The plurality of client devices 202 are each configured to include a computer-readable medium 209, such as random access memory, coupled to a processor 208. Processor 208 executes program instructions stored in the computer-readable medium 209. In another embodiment, the plurality of client devices 202 may also include a number of additional external or internal devices, such as, without limitation, a mouse, a CD-ROM, a keyboard, and a display.

The interface framework may be stored on the plurality of client devices 202 within each computer-readable medium 209.

Similar to the plurality of client devices 202, the server device 210 may include a processor 211 coupled to a computer-readable medium 212. The server device 210 may also include a number of additional external or internal devices, such as, without limitation, a secondary storage element, such as database 240.

The interface framework may be stored on the server device 210 within each computer-readable medium 212.

The plurality of client processors 208 and the server processor 211 can be any of a number of well known computer processors, such as processors from Intel Corporation, of Santa Clara, Calif. In general, the plurality of client devices 202 may be any type of computing platform connected to a network and that interacts with application programs, such as a digital assistant or a “smart” cellular telephone or pager. The server 210, although depicted as a single computer system, may be implemented as a network of computer processors.

The plurality of client devices 202 and the server 210 may include the portions of the invention. In one embodiment, the plurality of computer-readable medium 209 and 212 may contain, in part, a portion of the invention. Additionally, the plurality of client devices 202 and the server 210 are configured to receive and transmit electronic messages for use with the invention. Similarly, the network 201 is configured to transmit electronic messages for use with the invention.

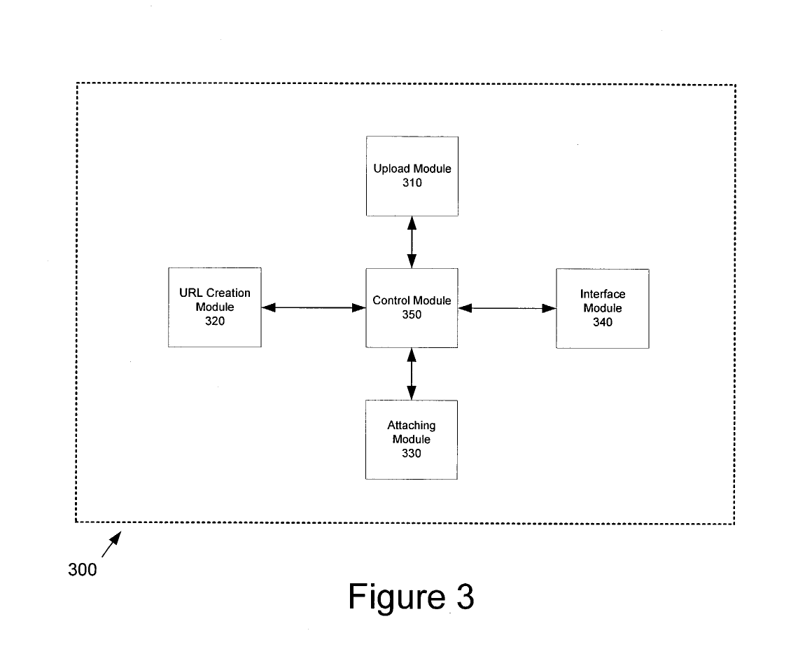

FIG. 3 illustrates one embodiment of a system 300. In one embodiment, the system 300 is configured to perform any or all of the following: upload content to a remote device, create a URL associated to the content, automatically attach the URL to an electronic message, and/or view the uploaded content.

In one embodiment, the sent electronic message may contain both the URL corresponding to the content and a thumbnail image which displays at least a portion of the content.

The system 300 includes an upload module 310, a URL creation module 320, an attachment module 330, an interface module 340, and a control module 350. In one embodiment, the control module 350 is configured to communicate with the upload module 310, the URL creation module 320, the attachment module 330, and the interface module 340.

In one embodiment, the control module 350 is configured to coordinate tasks, requests and communications between the upload module 310, the URL creation module 320, the attachment module 330, and the interface module 340.

In one embodiment, the upload module 310 is configured to upload image data to a target server. For example, the image data may resides within the sender's computer, a remote server, or the target server. If the image data resides within the sender's computer or a remote server, the image data is uploaded to the target server.

In one embodiment, the target server is a photo album application. In one embodiment, the image data may be stored within the target server. In one embodiment, the image data may be stored in a TIFF format, a JPEG format, and the like.

In another embodiment, the target server is a content storage server which is configured to store a variety of content. This content may include documents, music selections, and the like.

In yet another embodiment, the target server may be the same device as the sender's device.

In one embodiment, the upload module 310 may identify the location of the image data and coordinate the transmission of the image data to the target server.

In one embodiment, the URL creation module 320 is configured to identify a specific image or multiple selected images and to associate a URL with the specific image(s). For example, if a plurality of images are stored within the target server, the URL creation module 320 may be configured to identify the specific image(s) from the plurality of images. Next, these specific image(s) are associated with an URL that corresponds with these specific image(s).

In one embodiment, the attachment module 330 is configured for embedding the URL that corresponds to specific image(s) within an electronic mail message created by the sender.

For example, the attachment module 330 automatically embeds the URL which was created in the URL creation module 320 into an electronic mail message which is created by the sender and addressed to a recipient. The resulting electronic mail message may be opened by the recipient. After opening the electronic mail message, the recipient may view the specific image(s) through the URL.

Accordingly, the sender may transmit an electronic mail message to the recipient which allows the recipient to view the specific image(s) without directly sending the specific image(s) to the recipient. The sender may seamlessly and automatically embed the specific image(s) within the electronic mail message while creating this electronic mail message for the recipient.

In one embodiment, the interface module 340 is configured to receive sender instructions to operate the system 300. In one embodiment, the interface module 340 is configured to receive any of the following: an image selection from a sender, recipient information, message content, and the like.

The system 300 in FIG. 3 is shown for exemplary purposes and is merely embodiment of the invention. Additional modules may be added to the system 300 without departing from the scope of the invention. Similarly, modules may be combined or deleted without departing from the scope of the invention.

B. Operation

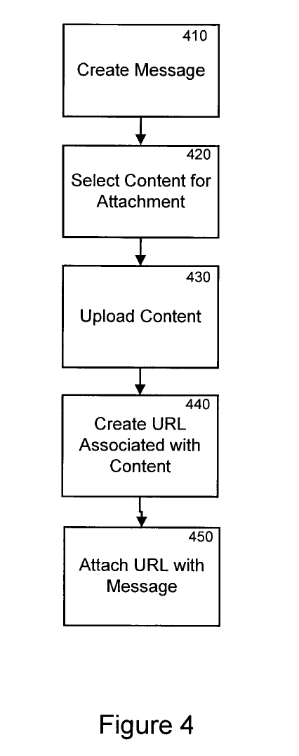

The flow diagrams as depicted in FIGS. 4, 5, and 6 are merely one embodiment of the invention. The blocks within the flow diagrams may be performed in a different sequence without departing from the spirit of the invention. Further, blocks may be deleted, added, or combined without departing from the spirit of the invention.

The flow diagram in FIG. 4 illustrates attaching content data to a message according to one embodiment of the invention.

In Block 410, a message is created. In one embodiment, the message is an electronic mail message. The message may include information identifying the recipient and/or a corresponding text message directed to the recipient.

In one embodiment, the message is created on an email application residing on the sender's local device such as Microsoft Outlook™. In another embodiment, the message is created on an on-line email application residing in a remote location relative to the sender's local device such as Hotmail™.

In Block 420, a selection is made by the sender to identify content. The content identified by the sender is selected to be attached to the message created to be sent to the recipient. In one embodiment, the content includes one of an image, a document, a music selection, an A/V presentation, and the like.

In Block 430, content data which corresponds to the content selected by the sender is uploaded to a target server. In one embodiment, the content data is located outside the target server. In another embodiment, the content data is already located within the target server. In one embodiment, the upload module 310 (FIG. 3) may be utilized to upload the content data to the target server.

In Block 440, a URL is created to correspond with the content data. In one embodiment, the URL is configured to uniquely correspond to a location within the target server which stores the content data that represents the content selected by the sender. Accordingly, accessing the URL allows the content associated with the content data to be displayed.

In Block 450, the electronic mail message is embedded with the URL. In one embodiment, the URL is displayed within the electronic mail message. For example, the recipient opens the electronic mail message and is prompted to select the embedded URL. Once the URL is selected, the recipient may view the selected content.

In another embodiment, the URL is automatically activated upon the recipient opening the electronic mail message. For example, the recipient opens the electronic mail message. Next, the embedded URL is automatically selected which causes the content corresponding to the content data to be displayed for the recipient.

In yet another embodiment, the URL is displayed within the electronic mail message in addition to a thumbnail icon which represents at least a portion of the content which is embedded within the electronic mail message.

The content upload in the Block 430, the URL creation in the Block 440, and the URL attachment in the Block 450 are configured to be automatically performed without intervention from the sender.

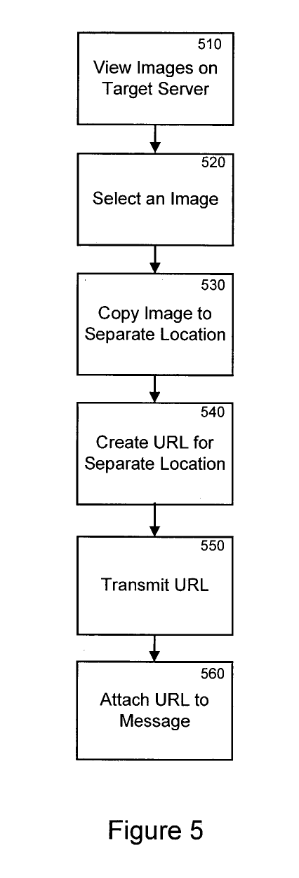

The flow diagram in FIG. 5 illustrates generating image data and attaching the image data to a message according to one embodiment of the invention.

In Block 510, a plurality of images may be viewed by the sender. In one embodiment, these images are located on a target server. In one embodiment, this target server hosts a photo album application such as ImageStation^{SM}. In one embodiment, the plurality of images are stored and configured as a photo album.

In Block 520, a selection is made by the sender to identify an image from the multiple images. The image identified by the sender is selected to be attached to the message created to be sent to the recipient. In one embodiment, a single image is selected by the sender. In another embodiment, multiple images are selected by the sender for attachment to the message.

In Block 530, the selected image is copied to a specific location. For example, the selected image is separated from the plurality of images as viewed in the Block 510. Specifically, the selected image is duplicated. This duplicated image is stored within the target server but separate from the plurality of images. In this embodiment, the plurality of images may still be viewed as a single photo album while also having the selected image stored separately from the plurality of images.

In Block 540, a URL is created to correspond with the selected image. In one embodiment, the URL is configured to uniquely correspond to a location within the target server which stores the selected image. The location of the selected image differs from the location of the plurality of images. Accordingly, accessing the URL allows the selected image to be displayed.

In Block 550, the URL created in the Block 540 is transmitted to the location in which an electronic mail message is being created by the sender for receipt by the recipient.

In Block 560, the electronic mail message is embedded with the URL. In one embodiment, the URL is displayed within the electronic mail message. For example, the recipient opens the electronic mail message and is prompted to select the embedded URL. Once the URL is selected, the recipient may view the selected image.

In another embodiment, the URL is automatically activated upon the recipient opening the electronic mail message. For example, the recipient opens the electronic mail message. Next, the embedded URL is automatically selected which causes the image corresponding to the image data to be displayed for the recipient.

In yet another embodiment, the URL is displayed within the electronic mail message in addition to a thumbnail icon which represents at least a portion of the content which is embedded within the electronic mail message.

The image copy in the Block 530, the URL creation in the Block 540, the URL transmission in the Block 550, and the URL attachment in the Block 560 are configured to be automatically performed without intervention from the sender.

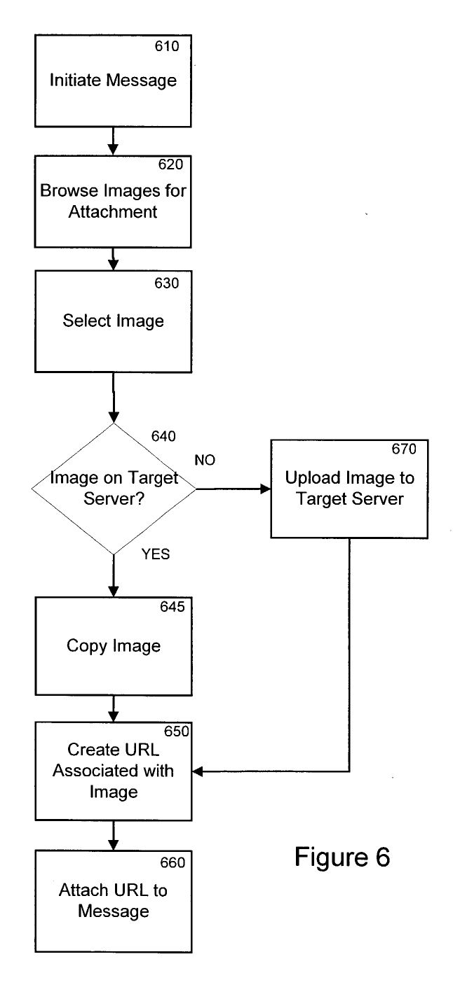

The flow diagram in FIG. 6 illustrates generating image data and attaching the image data to a message according to one embodiment of the invention.

In Block 610, an electronic mail message is initiated by a sender for transmission to a recipient.

In Block 620, the sender is able to browse for images to include within the electronic mail message. The sender may browser for images stored locally within the sender's device, images stored within a remote location, and/or images stored within the target server. In one embodiment, this target server hosts a photo album application such as ImageStation^{SM}.

In Block 630, a selection is made by the sender to identify an image to be attached to the electronic mail message. The image identified by the sender is selected to be attached to the message created to be sent to the recipient. In one embodiment, a single image is selected by the sender. In another embodiment, multiple images are selected by the sender for attachment to the message.

In Block 640, the location where the image selected by the sender for attachment to the electronic mail message is determined.

If the selected image is stored within the target server, the selected image is copied to a specific location within the target server within Block 645. For example, the selected image is separated from other images stored within the target server. Specifically, the selected image is duplicated. This duplicate image is stored within the target server but separate from other images. In this embodiment, the other images may still be viewed on the target server prior to the duplicating the selected image while also having the selected image stored separately from the images.

If the selected image is stored outside the target server, the selected image is uploaded to the target server within a Block 670. In one embodiment, the upload module 310 (FIG. 3) may be utilized to upload the image data to the target server.

After duplicating the selected image in the Block 645 or uploading the selected image in the Block 670, a URL is created to correspond with the selected image within a Block 650. In one embodiment, the URL is configured to uniquely correspond to a location within the target server which stores the selected image. The location of the selected image differs from the location of the plurality of images. Accordingly, accessing the URL allows the selected image to be displayed.

In Block 660, the electronic mail message is embedded with the URL. In one embodiment, the URL is displayed within the electronic mail message. For example, the recipient opens the electronic mail message and is prompted to select the embedded URL. Once the URL is selected, the recipient may view the selected image.

In another embodiment, the URL is automatically activated upon the recipient opening the electronic mail message. For example, the recipient opens the electronic mail message. Next, the embedded URL is automatically selected which causes the image corresponding to the image data to be displayed for the recipient.

In yet another embodiment, the URL is displayed within the electronic mail message in addition to a thumbnail icon which represents at least a portion of the content which is embedded within the electronic mail message.

The image copy in the Block 645, the URL creation in the Block 650, the image upload in the Block 670, and the URL attachment in the Block 660 are configured to be automatically performed without intervention from the sender.

C. Conclusion

The foregoing descriptions of specific embodiments of the invention have been presented for purposes of illustration and description. For example, the invention is described within the context of creating profiles for modifying digital images as merely one embodiment of the invention. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed:

1. A method comprising:
initiating an electronic mail message;
selecting a content for attachment to the electronic mail message;
automatically creating a URL corresponding to the content; and
automatically embedding the URL within the electronic mail message.

2. The method according to claim 1 further comprising viewing the content through the URL.

3. The method according to claim 1 further comprising browsing through a plurality of content prior to selecting the content.

4. The method according to claim 1 further comprising uploading the content to a target server wherein the URL corresponds to the content on the target server.

5. The method according to claim 4 further comprising storing the content on the target server.

6. The method according to claim 1 further comprising separating the content from other content.

7. The method according to claim 1 further comprising receiving the electronic mail message and displaying the content.

8. The method according to claim 7 wherein displaying the content is accomplished automatically upon opening the electronic mail message.

9. The method according to claim 7 wherein displaying the content is accomplished by selecting the URL.

10. The method according to claim 1 wherein the content is an image.

11. The method according to claim 1 wherein the image is one of a TIFF file, a JPEG file, and an MPEG file.

12. The method according to claim 1 further comprising sending the electronic mail message to a recipient with the URL embedded within the electronic mail message corresponding to the image.

13. The method according to claim 1 wherein the target server is a photo album application.

14. The method according to claim 1 wherein the target server is a content storage application.

15. The method according to claim 1 further comprising receiving the electronic mail message and making the content available to recipient of the electronic mail message.

16. The method according to claim 1 wherein the content is a document.

17. The method according to claim 1 wherein the content is a music selection.

18. A method comprising:
initiating an electronic mail message;
browsing a plurality of images;
selecting a selected image from the plurality of images for attachment to the electronic mail message;
determining a location of the selected image;
selectively uploading the selected image to a target server;
automatically creating a URL corresponding to the selected image; and
automatically embedding the URL within the electronic mail message.

19. The method according to claim 13 further comprising selectively copying the selected image to a separate location on the target server based on the location of the selected image.

20. The method according to claim 13 further comprising opening the electronic mail message.

21. The method according to claim 15 further automatically displaying the selected image upon opening the electronic mail message.

22. The method according to claim 15 further displaying the selected image in response to selecting the URL.

23. A system, comprising:
an upload module configured for selectively uploading content to a server;
a URL creation module configured for automatically assigning a URL to correspond with the content; and
an attaching module configured for automatically embedding the URL within an electronic mail message.

24. The system according to claim 23 wherein the content is an image.

25. The device according to claim 23 wherein the content is a document.

26. The device according to claim 23 wherein the content is a music selection.

27. The device according to claim 23 wherein the electronic mail message includes the URL embedded within the electronic mail message which allows a recipient of the electronic mail message to access the content directly through the server.

28. The device according to claim 23 wherein the URL allows a recipient of the electronic mail message to gain access to the content directly through the server.

29. A system, comprising:
means for uploading configured for selectively uploading content to a server;
means for creating a URL configured for automatically assigning a URL to correspond with the content; and
means for attaching configured for automatically embedding the URL within an electronic mail message.

30. A computer-readable medium having computer executable instructions for performing a method comprising:
A method comprising:
initiating an electronic mail message;
selecting a content for attachment to the electronic mail message;
automatically creating a URL corresponding to the content; and
automatically embedding the URL within the electronic mail message.
